(19) United States
(12) Patent Application Publication
(10) Pub. No.: US 2021/0024146 A1
(43) Pub. Date: Jan. 28, 2021

(54) AUTOMOTIVE VEHICLE

(71) Applicant: TOYOTA JIDOSHA KABUSHIKI KAISHA, Toyota-shi (JP)

(72) Inventors: Ikuo OHTA, Toyota-shi (JP); Hideshi MIZUTANI, Toyota-shi (JP); Atsushi SAJIKI, Okazaki-shi (JP); Takao INATA, Setagaya-ku (JP); Yohei TANIGAWA, Toyota-shi (JP); Atsushi NAKAJIMA, Kariya-city (JP); Atsuo KOMATSUBARA, Nagakute-shi (JP)

(21) Appl. No.: 16/932,961

(22) Filed: Jul. 20, 2020

(30) Foreign Application Priority Data
Jul. 26, 2019 (JP) 2019-137709

(51) Int. Cl. B62D 51/04; B60W 50/14; B60W 60/00

(52) U.S. Cl. CPC B62D 51/04; B60W 50/14; B60W 2556/40; B60W 2554/802; B60W 2420/42; B60W 60/0021

(57) ABSTRACT

An automotive vehicle according to the present disclosure is an automotive vehicle deployed at an airport, the automotive vehicle including: an information collection unit configured to collect arrival and departure information of an aircraft which a user boards; a derivation unit configured to derive a boarding place and a boarding time for the user to board the aircraft based on the arrival and departure information pieces; a user recognition unit configured to recognize the user; a distance measurement unit configured to measure a distance between the automotive vehicle and the user; and a traveling control unit configured to control traveling of the automotive vehicle. The traveling control unit controls the automotive vehicle to travel to the boarding place by the boarding time while guiding the user and preventing the automotive vehicle and the user from being spaced apart from each other by a predetermined distance or more.

### CROSS REFERENCE TO RELATED APPLICATIONS

This application is based upon and claims the benefit of priority from Japanese patent application No. 2019-137709, filed on Jul. 26, 2019, the disclosure of which is incorporated herein in its entirety by reference.

### BACKGROUND

The present disclosure relates to an automotive vehicle deployed at an airport.

In recent years, airports have been conducting various studies to guide users to their boarding places. For example, Japanese Unexamined Patent Application Publication No. 2014-170120 discloses a guidance display apparatus that displays, in the order of departure times, operation information including a destination, a departure time, and a boarding gate.

### SUMMARY

However, according to the guidance display apparatus disclosed in Japanese Unexamined Patent Application Publication No. 2014-170120, a user may not be able to always arrive at the boarding place by the boarding time although the user can find the boarding place.

The present disclosure has been made in view of the aforementioned circumstances and an object thereof is to provide an automotive vehicle capable of reducing the possibility that a user of an airport cannot arrive at a boarding place by a boarding time.

A first exemplary aspect is an automotive vehicle deployed at an airport, the automotive vehicle including:

an information collection unit configured to collect arrival and departure information of an aircraft which a user boards;

a derivation unit configured to derive a boarding place and a boarding time for the user to board the aircraft based on the arrival and departure information pieces collected by the information collection unit;

a user recognition unit configured to recognize the user;

a distance measurement unit configured to measure a distance between the automotive vehicle and the user; and

a traveling control unit configured to control traveling of the automotive vehicle, in which

the traveling control unit controls the automotive vehicle to travel to the boarding place by the boarding time while guiding the user and preventing the automotive vehicle and the user from being spaced apart from each other by a predetermined distance or more based on the distance measured by the distance measurement unit.

According to the above-described present disclosure, it is possible to provide an automotive vehicle capable of reducing the possibility that a user of an airport cannot arrive at a boarding place by a boarding time.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a diagram showing an example of an appearance configuration of an automotive vehicle according to an embodiment;

FIG. 2 is a block diagram showing an example of a block configuration of a control apparatus of the automotive vehicle according to the embodiment; and

FIG. 3 is a flowchart showing a flow of processing performed by the automotive vehicle according to the embodiment.

### DESCRIPTION OF EMBODIMENTS

Hereinafter, although the present disclosure will be described with reference to an embodiment of the present disclosure, the present disclosure according to claims is not limited to the following embodiment. Moreover, all the components described in the following embodiment are not necessarily essential for means for solving problems. For the clarification of the description, the following description and the drawings may be omitted or simplified as appropriate. Throughout the drawings, the same components are denoted by the same reference signs and repeated descriptions will be omitted as appropriate.

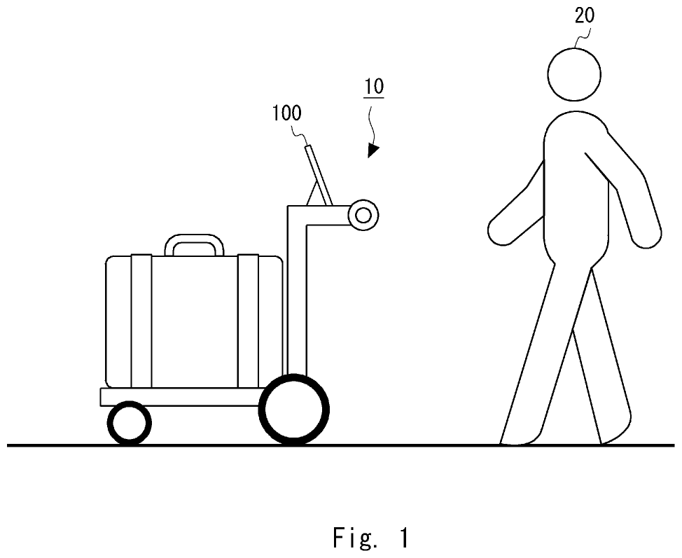

First, an appearance configuration of an automotive vehicle 10 according to this embodiment is described with reference to FIG. 1.

As shown in FIG. 1, the automotive vehicle 10 according to this embodiment is a self-propelled cart that is deployed at an airport and is able to carry luggage. Further, the automotive vehicle 10 is parked and kept on standby, for example, near exits of a security checkpoint and a passport control area of the airport and starts operating when a user 20 performs a predetermined operation (e.g., pressing an activation button or a start button). Then, the automotive vehicle 10 guides the user 20 as it travels to the boarding place where the user 20 boards the aircraft. Further, the automotive vehicle 10 includes a control apparatus 100 for controlling such traveling. Note that in the following description, while the control apparatus 100 will be described as being implemented by a tablet terminal or the like including a display unit, a camera, etc., this configuration is merely an example.

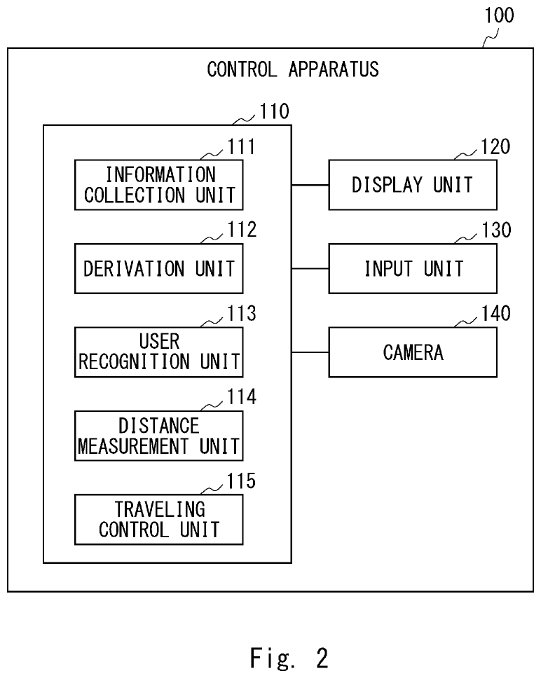

Next, a block configuration of the control apparatus 100 included in the automotive vehicle 10 according to this embodiment is described with reference to FIG. 2.

As shown in FIG. 2, the control apparatus 100 according to this embodiment includes a processing unit 110 that performs various types of processing, a display unit 120 that displays various types of information, an input unit 130 to which the user 20 performs an input operation, and a camera 140 capable of photographing surroundings of the automotive vehicle 10 (particularly the rear of the automotive vehicle 10). Note that the display unit 120 and the input unit 130 may be integrated and implemented as a touch panel. Further, the processing unit 110 includes an information collection unit 111, a derivation unit 112, a user recognition unit 113, a distance measurement unit 114, and a traveling control unit 115.

The information collection unit 111 collects arrival and departure information of the aircraft which the user 20 boards. The arrival and departure information includes at least information about the flight number of the aircraft. If the flight number of the aircraft is known, the date and time of arrival and departure of the aircraft can be determined by checking the flight number against the database and the like of the airport. Therefore, it is optional to include the information about the date and time of arrival and departure of the aircraft in the arrival and departure information. Further, for example, the information collection unit 111 may collect arrival and departure information by urging the user 20 to present a boarding pass of the user 20 via the display unit 120, photographing the boarding pass with the camera 140, and reading the barcode described in the boarding pass. Alternatively, the information collection unit 111 may urge the user 20 to input arrival and departure information to the input unit 130 via the display unit 120 and may collect the arrival and departure information input to the input unit 130.

The derivation unit 112 derives a boarding place and a boarding time for the user 20 to board the aircraft based on the arrival and departure information pieces collected by the information collection unit 111. For example, the derivation unit 112 may derive a boarding place by checking the flight number included in the arrival and departure information against the database and the like of the airport. Further, the derivation unit 112 may derive a predetermined time before the departure time of the aircraft as a boarding time. Note that if the arrival and departure information only includes the flight number, the derivation unit 112 may acquire the date and time of arrival and departure of the aircraft by checking the flight number against the database and the like of the airport.

The user recognition unit 113 recognizes the user 20. For example, the user recognition unit 113 may recognize the user 20 by, at the start of an operation of the automotive vehicle 10, urging the user 20 to turn his/her face toward it via the display unit 120, photographing the face of the user 20 with the camera 140, and after that, the user recognition unit 113 may recognize the user 20 by recognizing the image of the face of the user 20.

The distance measurement unit 114 measures a distance between the automotive vehicle 10 and the user 20. For example, in a photographed image obtained by taking an image including the face of the user 20 with the camera 140, it can be determined that the distance between the automotive vehicle 10 and the user 20 is short if the ratio of the vertical (or the horizontal) length of the face of the user 20 to the vertical (or the horizontal) frame length of the photographed image is high, while it can be determined that the distance between the automotive vehicle 10 and the user 20 is long if the aforementioned ratio is low. Therefore, for example, the distance measurement unit 114 may measure a distance between the automotive vehicle 10 and the user 20 based on the ratio of the vertical (or the horizontal) length of the face of the user 20 to the vertical (or the horizontal) frame length of the photographed image.

The traveling control unit 115 controls the automotive vehicle 10 to travel to the boarding place by the boarding time derived by the derivation unit 112 while guiding the user 20 and preventing the automotive vehicle 10 and the user 20 from being spaced apart from each other by a predetermined distance or more based on the distance measured by the distance measurement unit 114. At this time, the traveling control unit 115 may determine a traveling route for the automotive vehicle 10 to the boarding place based on the map of the airport, the current location of the automotive vehicle, and the boarding place. Further, the traveling control unit 115 may determine a traveling speed of the automotive vehicle 10 based on the determined traveling route, the current time, and the boarding time. At this time, the traveling control unit 115 determines the traveling speed of the automotive vehicle 10 so that it does not exceed the allowable maximum speed allowed for the automotive vehicle 10. Further, the traveling control unit 115 may use an existing technique for avoiding collisions in order to prevent the automotive vehicle 10 which is travelling from colliding with a person or the like. Note that in regard to stationary obstacles (e.g., pillars, chairs, and horizontal escalators) in the airport, at the stage of determining the traveling route, the traveling control unit 115 may determine the traveling route so that the automotive vehicle 10 avoids these obstacles.

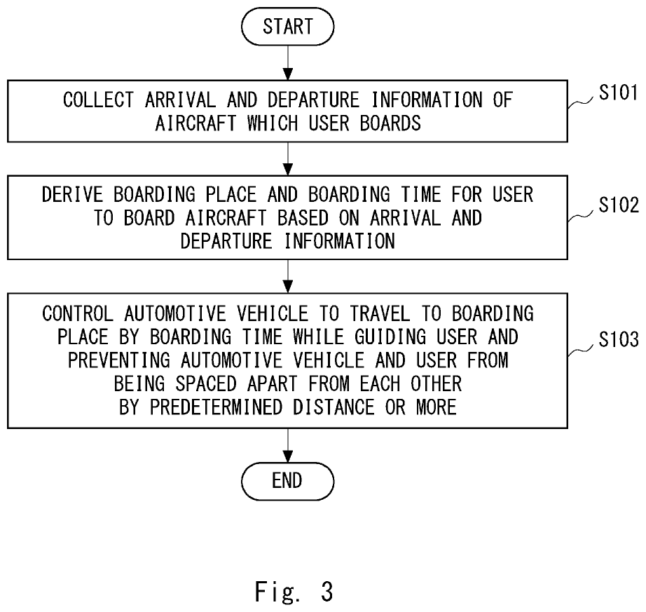

Next, a flow of processing performed by the automotive vehicle 10 according to this embodiment is described with reference to FIG. 3.

As shown in FIG. 3, first, the information collection unit 111 collects arrival and departure information of the aircraft which the user 20 boards (Step S101).

Next, the derivation unit 112 derives a boarding place and a boarding time for the user 20 to board the aircraft based on the arrival and departure information pieces collected by the information collection unit 111 (Step S102).

Thereafter, the user recognition unit 113 continuously performs the operation of recognizing the user 20, and the distance measurement unit 114 continuously performs the operation of measuring the distance between the automotive vehicle 10 and the user 20.

Then, the traveling control unit 115 controls the automotive vehicle 10 to travel to the boarding place by the boarding time while guiding the user 20 and preventing the automotive vehicle 10 and the user 20 from being spaced apart from each other by a predetermined distance or more (Step S103).

Next, an effect of the automotive vehicle 10 according to this embodiment is described.

In the automotive vehicle 10 according to this embodiment, arrival and departure information of the aircraft which the user 20 boards is collected, and a boarding place and a boarding time for the user 20 to board the aircraft are derived based on the collected arrival and departure information pieces. Then, the automotive vehicle 10 is controlled to travel to the boarding place by the boarding time while guiding the user 20 and preventing the automotive vehicle 10 and the user 20 from being spaced apart from each other by a predetermined distance or more. This configuration enables a reduction of the possibility that the user 20 cannot arrive at the boarding place by the boarding time.

Further, the automotive vehicle 10 travels so that the automotive vehicle 10 and the user 20 do not become spaced apart from each other by a predetermined distance or more. By doing so, it is possible to avoid a situation where the user 20 leaves the automotive vehicle 10 on the way and only the automotive vehicle 10 arrives at the boarding place.

Note that the present disclosure is not limited to the above-described embodiment and can be modified as appropriate without departing from the spirit of the present disclosure.

For example, the traveling control unit 115 may give an alert when it determines that the automotive vehicle 10 and the user 20 are spaced apart from each other by a predetermined distance or more. As a method for giving an alert in this case, for example, a method for outputting an alarm sound through a speaker (not shown) provided in the automotive vehicle 10 can be considered. Further, when the traveling control unit 115 determines that the automotive vehicle 10 and the user 20 are spaced apart from each other by a predetermined distance or more, the traveling control unit 115 may stop the automotive vehicle 10.

Further, the traveling control unit 115 may give an alert when the user recognition unit 113 can no longer recognize the user 20. As a method for giving an alert in this case, for example, a method for contacting the airport management company or the airline of the aircraft which the user 20 boards can be considered.

Further, the traveling control unit 115 may determine a traveling route for the automotive vehicle 10 to the boarding place based on the map of the airport, the current location of the automotive vehicle 10, and the boarding place, and may determine a traveling speed of the automotive vehicle 10 based on the determined traveling route, the current time, and the boarding time. At this time, the traveling control unit 115 may give an alert when it determines that the automotive vehicle 10 cannot arrive at the boarding place by the boarding time even if it travels on the traveling route at the allowable maximum speed allowed for the automotive vehicle 10. As a method for giving an alert in this case, for example, a method for contacting the airline of the aircraft which the user 20 boards can be considered.

Further, the automotive vehicle 10 may have a recommendation function. For example, the automotive vehicle 10 may present, to the user 20, a store which it recommends to the user 20 via the display unit 120. Further, when the user 20 selects a store genre via the input unit 130, the automotive vehicle 10 may present, to the user 20, a store which it recommends from among the stores of the genre selected by the user 20 via the display unit 120. Further, the recommendation function may be enabled or disabled. Further, the automotive vehicle 10 may provide services such as discounting travel expenses to the user 20 who, for example, has enabled the recommendation function and has purchased a product at a store recommended by the automotive vehicle 10.

Further, in the above-described embodiments, the control apparatus of the automotive vehicle according to the present disclosure has been described as a hardware configuration, but the present disclose is not limited thereto. In the present disclosure, any processing of the control apparatus of the automotive vehicle can be achieved by a processor, such as a CPU (Central Processing Unit), loading and executing a computer program stored in a memory. The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An automotive vehicle deployed at an airport, the automotive vehicle comprising:
an information collection unit configured to collect arrival and departure information of an aircraft which a user boards;
a derivation unit configured to derive a boarding place and a boarding time for the user to board the aircraft based on the arrival and departure information pieces collected by the information collection unit;
a user recognition unit configured to recognize the user;
a distance measurement unit configured to measure a distance between the automotive vehicle and the user; and
a traveling control unit configured to control traveling of the automotive vehicle, wherein
the traveling control unit controls the automotive vehicle to travel to the boarding place by the boarding time while guiding the user and preventing the automotive vehicle and the user from being spaced apart from each other by a predetermined distance or more based on the distance measured by the distance measurement unit.

2. The automotive vehicle according to claim 1, wherein the traveling control unit gives an alert when the traveling control unit determines that the automotive vehicle and the user are spaced apart from each other by a predetermined distance or more.

3. The automotive vehicle according to claim 1, wherein the traveling control unit gives an alert when the user recognition unit can no longer recognize the user.

4. The automotive vehicle according to claim 1, wherein the traveling control unit gives an alert when the traveling control unit determines a traveling route for the automotive vehicle to the boarding place based on a map of the airport, a current location of the automotive vehicle, and the boarding place and determines that the automotive vehicle cannot arrive at the boarding place by the boarding time even if it travels on the traveling route at an allowable maximum speed allowed for the automotive vehicle.
